(19) United States
(12) Patent Application Publication
(10) Pub. No.: US 2018/0346364 A1
(43) Pub. Date: Dec. 6, 2018

(54) DEWATERING WHOLE STILLAGE

(71) Applicant: NOVOZYMES A/S, Bagsvaerd (DK)

(72) Inventor: Chee-Leong Soong, Raleigh, NC (US)

(73) Assignee: NOVOZYMES A/S, Bagsvaerd (DK)

(21) Appl. No.: 15/781,311

(22) PCT Filed: Dec. 5, 2016
(86) PCT No.: PCT/US2016/065012

§ 371 Date: Jun. 4, 2018

Related U.S. Application Data
(60) Provisional application No. 62/264,494, filed on Dec. 8, 2015.

(51) Int. Cl. C02F 11/14; C02F 3/34; A23K 10/14; A23K 10/38; C02F 1/38; C02F 1/00

(52) U.S. Cl. CPC C02F 11/14; C12Y 302/01006; C12Y 302/01039; C12Y 302/01073; C02F 2103/26; A23K 10/14; A23K 10/38; C02F 1/385; C02F 1/001; C02F 3/342

(57) ABSTRACT

The invention relates to methods of dewatering of whole stillage derived from a fermentation product production process using yeast-degrading enzymes.

### FIELD OF THE INVENTION

The present invention relates to processes of dewatering whole stillage derived from a fermentation product production process.

### BACKGROUND OF INVENTION

In corn to ethanol production, whole stillage is produced after distillation. Whole stillage is dewatered and separated into a solid phase (wet cake) and liquid phase (thin stillage) by decanter/centrifugation. Dewatered wet cake is dried to produce “Distillers Dried Grain with Solid” (DDGS) used as animal feed.

Presently, approximately 70% of the total whole stillage produced in USA is being dried and sold as DDGS. The drying of wet cake to DDGS is typically handled by direct-fired rotary drum drier using natural gas which consumed about 30-38% of total energy used in ethanol plant.

Thus, there is a need for improving processes involved in dewatering of whole stillage.

### BRIEF DESCRIPTION OF THE DRAWINGS

FIG. 1 is a graph showing that yeast cells have strong water retention capacity.

FIG. 2 schematically shows the application of laminarinase and/or lyticase to whole stillage.

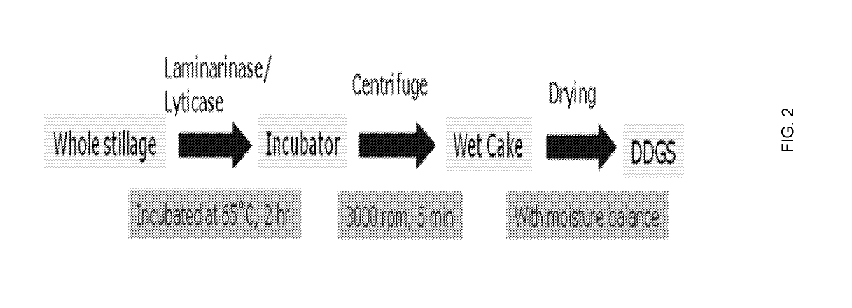

FIG. 3 is a graph showing the addition of laminarinase or lyticase to whole stillage and its effect on the drying rate of wet cake.

FIG. 4 is a graph showing the addition of laminarinase or lyticase to yeast suspension and its effect on the drying rate of yeast-cell cake.

### DESCRIPTION OF THE INVENTION

The object of the present invention is to provide a method of dewatering whole stillage.

The present inventor has surprisingly found an improved process for dewatering of whole stillage. Enzymatic solutions which reduce water holding/retention of whole stillage would reduce the natural gas consumption for drying wet cake thus resulting in energy cost savings.

Yeast and its cell components constitute approximately 11.8% (w/w) of whole stillage. It has been found that yeast cells have a strong water retention capacity and that the addition of yeast cells to whole stillage significantly reduces the drying rate and increases the drying time.

Yeast cell wall is a latticework of structural units each being composed of a branched β-1,3-glucan molecule, presenting multiple attachment sites for both β-1,6-glucan and chitin chains. By using enzymes which hydrolyze or degrade yeast cells in whole stillage this will reduce the water retention/holding capacity of whole stillage.

In accordance with the present invention, yeast-degrading enzymes such as laminarinase and lyticase or zymolase (EC 3.2.1.6 or 3.2.1.39 or 3.2.1.73) are enzymes used to lysis and degrade yeast cells.

According to the present invention there is provided a method of dewatering whole stillage comprising the steps of

(i) subjecting whole stillage to one or more enzymes capable of degrading yeast cell wall components,

(ii) separating the material into a solid fraction and a liquid fraction.

Preferably, wherein the enzyme capable of degrading yeast wall components is selected from the group of laminarinase, lyticase and zymolase.

Optionally, the whole stillage is derived from a process of producing a fermentation product, preferably a liquid fermentation product.

Preferably, the whole stillage is derived from a process of producing a fermentation product utilizing starch-containing material as a feedstock. The feedstock is selected from the group consisting of corn, wheat, barley, cassava, sorghum, rice, tapioca, rye, potato, sweet potato or any combination thereof.

In accordance with the present invention, the fermentation product is an alcohol, preferably ethanol.

In accordance with one aspect of the invention, the enzyme is added to the whole stillage after the distillation process. Optionally, the enzyme is added during the fermentation process. A further option is wherein the enzyme is added to the beer well before the distillation process.

Preferably, wherein the method according to the present invention further comprises a step (iii) of drying the solid fraction.

Optionally, wherein the separation in step (ii) is carried out by centrifugation, preferably a decanter centrifuge. A further option is where the separation in step (ii) is carried out by filtration, preferably using a filter press, a screw press, a plate-and-frame press, a gravity thickener or decker.

Preferably, wherein step (i) is carried out at a temperature up to 65° C., more preferably at a temperature of from 20 to 65° C.

Preferably, wherein the step (i) is carried out at a pH range of from 4 to 5, preferably 4.5.

Whole Stillage and Production of Fermentation Products

The method of the invention may be used on whole stillage derived from production of any suitable fermentation product. The feedstock for producing the fermentation product may be any starch-containing material, preferably starch-containing plant material, including: tubers, roots, whole grain; and any combination thereof. The starch-containing material may be obtained from cereals. Suitable starch-containing material includes corn (maize), wheat, barley, cassava, sorghum, rice, tapioca, rye, potato, sweet potato or any combination thereof. Corn or wheat are the preferred feedstocks, especially when the fermentation product is ethanol. The starch-containing material may also consist of or comprise, e.g., a side stream from starch processing, e.g., C₆ carbohydrate containing process streams that may not be suited for production of syrups. Whole stillage typically contains about 10-15 wt-% dry solids. Whole stillage components include fiber, hull, germ, oil and protein components from the starch-containing feedstock as well as non-fermented starch.

Production of a fermentation product is typically divided into the following main process stages:

a) Reducing the particle size of starch-containing material, e.g., by dry or wet milling;

b) Cooking the starch-containing material in aqueous slurry to gelatinize the starch,

c) Liquefying the gelatinized starch-containing material in order to break down the starch (by hydrolysis) into maltodextrins (dextrins);

d) Saccharifying the maltodextrins (dextrins) to produce low molecular sugars (e.g., DP₁₋₂) that can be metabolized by a fermenting organism;

e) Fermenting the saccharified material using a suitable fermenting organism directly or indirectly converting low molecular sugars into the desired fermentation product;

f) Recovering the fermentation product, e.g., by distillation in order to separate the fermentation product from the fermentation mash.

The whole stillage is a by-product consisting of liquids and solids remaining after recovery (e.g. by distillation) of a desired fermentation product from fermented mash (beer mash).

According to the invention the fermentation product may be any fermentation product, including alcohols (e.g., ethanol, methanol, butanol, 1,3-propanediol); organic acids (e.g., citric acid, acetic acid, itaconic acid, lactic acid, gluconic acid, gluconate, succinic acid, 2,5-diketo-D-gluconic acid); ketones (e.g., acetone); amino acids (e.g., glutamic acid); gases (e.g., H₂ and CO₂), and more complex compounds, including, for example, antibiotics (e.g., penicillin and tetracycline); enzymes; vitamins (e.g., riboflavin, B₁₂, beta-carotene); and hormones. Fermentation is also commonly used in the consumable alcohol (e.g., beer and wine), dairy (e.g., in the production of yogurt and cheese), leather, and tobacco industries. In a preferred embodiment the fermentation product is a liquid, preferably an alcohol, especially ethanol.

The whole stillage contemplated may be the side-product resulting from a fermentation product production process including above mentioned steps a) to f). However, the whole stillage may also be the side-product resulting from other fermentation product production processes based on starch-containing starting material.

Dewatering of Whole Stillage

As discussed above, DDGS is principally used as a feed for, e.g., cattle. Approximately 25% of the product in the industry is sold as “wet” (60 to 65% water content) just after the centrifugation, and the remaining 75% is sold as “dry” DDGS where the wet cake was dried to approximately 9% water to allow for increased storage and shipping stability. Approximately 38% of total energy consumed by an ethanol plant is spent on removing water from whole stillage, through centrifugation and drying.

The present invention provides an enzymatic treatment of whole stillage which results in reduced water content in wet cake from 65 to 50%, preferably 60% and more preferably 55% (i.e. dewater 5 to 10%). As a result, a lower water holding capacity in the wet grain (after centrifugation) will therefore give several benefits to the drying process such as (1) savings in heating energy cost; (2) better nutritional and quality value of DDGS due to less heating; (3) improved return of investment for the ethanol plant; and (4) a reduced carbon dioxide footprint.

The yeast-degrading enzymes can be added to the whole stillage:

(i) after the distillation process;

(ii) during the fermentation process; and/or

(iii) into the beerwell before the distillation process.

When the enzymes are added during the fermentation process, it is preferable that they are added toward the end of the fermentation process where the yeast fermentation reaches a stationary phase.

Yeast-degrading enzymes can also be added to the beer well where in the ethanol production process all fermented mashes were collected before distillation. The yeast degrading enzymes break-up the intact yeast and release ethanol from those yeast cells, which further increases ethanol titer for distillation. Thus, because the yeast cell has already degraded, this will then reduce its ability to retain or hold water resulting in a dewatering effect in the whole stillage.

In addition to the technique discussed above, in order to remove a portion of the liquid/water, any suitable separation technique can be used, including centrifugation, pressing and filtration. In a preferred embodiment the dewatering is carried out by centrifugation. Preferred centrifuges in industry today are decanter type centrifuges, preferably high speed decanter type centrifuges. An example of a suitable centrifuge is the NX 400 steep cone series from Alfa Laval which is a high-performance decanter. Alternatively, the separation is carried out using other conventional separation equipment such as a plate/frame filter presses, belt filter presses, screw presses, gravity thickeners and deckers, or similar equipment.

Drying of Wet Cake

After the wet cake has been dewatered it may be dried in a drum dryer, spray dryer, ring drier, fluid bed drier or the like in order to produce DDG. The wet cake is preferably dried under conditions that do not denature proteins in the wet cake. The wet cake may be blended with syrup separated from the thin stillage fraction and dried into DDG with Solubles (DDGS).

Enzymes used for Treating Whole Stillage

The yeast degrading enzymes which have been found to be most effective in degrading yeast cell walls are Laminarinase and Lyticase or zymolase (EC 3.2.1.6 or 3.2.1.39 or 3.2.1.73).

Laminarinase is derived from Trichoderma sp and is available from Sigma-Aldrich.

Lyticase is derived from Athrobacter luteus and is available from Sigma-Aldrich.

Zymolase is a synonym for lyticase. Thus, reference to lyticase in this application also includes reference to zymolase.

Experimental

### Example 1

### Modification of Yeast using Laminarinase and Lyticase

The objective of the experiment was to determine if modifying yeast with laminarinase and lyticase affected the drying kinetics of yeast slurry.

For this experiment, rehydrated yeast (Red Star™) was treated with 2 different yeast hydrolyzing enzymes, laminarinase and lyticase (Sigma), at two doses. Approximately 20 g of yeast was rehydrated in 150 ml of buffer. Approximately 15 g of rehydrated yeast was added to a pre-weighed 50 mL incubation tube (Nalgene) and then reweighed. Enzymes were dose at a low concentration of 0.05 mg product/g DS and a high concentration of 0.2 mg product/g DS. Samples were then incubated at 65° C. for 2 hours in a water bath and vortexed every 30 minutes. The formula below was used to calculate the volume of each enzyme stock solution to add to the whole stillage:

$$Enz . dose ( ml ) = \frac{\begin{matrix}Final . enz . dose ( mg \text{/} g DS ) \times stillage weight ( g ) \times \\ Solid Content ( \% DS )\end{matrix}}{Conc . enzyme mg \text{/} ml}$$

After incubation, the samples were centrifuged in an Avanti JE Series centrifuge with JS 5.3 rotor (Beckman Coulter) and the supernatant was immediately decanted. After centrifugation, approximately 1.5 g of hydrolyzed yeast pellet was then analyzed using a Mettler-Toledo moisture balance with the “DDGS-STD” program. The drying curves recorded by the moisture balances were compared with the control samples.

Results

The data from the moisture balance was plotted and each treatment was compared to the control from the same moisture balance. The drying curves were analyzed by plotting the change in weight over time for the period of drying between 2 and 7 minutes, producing a linear plot. The slopes of these lines were calculated and compared to the slope of the control to obtain the percent increase in drying rate.

The slope analysis and rate increases of each enzyme treatment are shown in Table 1.

TABLE 1
Rate increases of laminarinase and lyticase

| | Dose (mg | Slope | % Δ |
|---|---|---|---|
| Enzyme | prod/g DS) | (Δ g/min) | from Ctl |
| Control | | −0.0153 | |
| Laminarinase | 0.05 | −0.0193 | 26.14% |
| | 0.2 | −0.0236 | 54.25% |
| Lyticase | 0.05 | −0.0205 | 33.99% |
| | 0.2 | −0.0222 | 45.10% |

It is observed that laminarinase and lyticase do produce an effect on yeast and all enzyme treatments increased drying rates from control.

### Example 2

### Effect of Yeast Cells Addition to Whole Stillage and Drying Rate of Wet Cake

20 g of industrial-produced whole stillage was added to a 50 mL incubation tube (Nalgene). Predefined amount of yeast was added into respective tube and incubated at 65° C. for 2 hours. Control of whole stillage without addition of yeast was prepared and incubated under the same conditions. After the incubation period, the whole stillage sample was transferred to a filter tube equipped with a 100 μM filter (Millipore) and subjected to centrifugation at 3000 rpm for 5 min. The wet grain or wet cake collected on top of the filter tube was transferred to aluminum pan and dry in moisture balance (Mettler Toledo). The moisture balance will record the sample weight changes in moisture loss at every 30 sec interval time. Recording of weight will stop automatically once the machine senses no further change in weight.

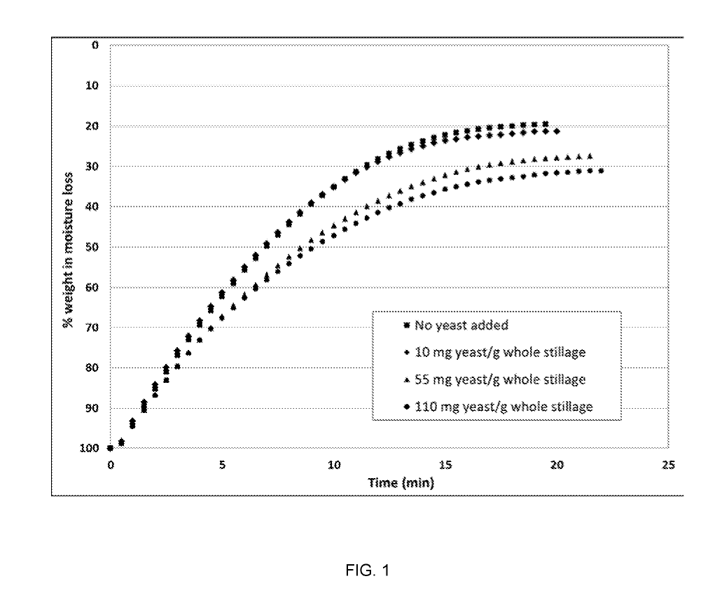

As shown in FIG. 1, presence of yeast cells clearly reduced the drying rate with higher amount of yeast correspondingly increased the drying time of wet cake.

### Example 3

### Effect of Laminarinase or Lyticase (Zymolase) Treatment of Whole Stillage on Drying Rate of Wet Cake

Laminarinase from Trichoderma sp. and lyticase (zymolase) from Arthrobacter luteus were commercially available from Sigma-Aldrich. 15 g of industrial-produced whole stillage was added to a 50 mL incubation tube (Nalgene). The appropriate amount of laminarinase or lyticase was added to whole stillage and incubated at 65° C. for 2 hours. Control of whole stillage without enzyme addition was prepared and incubated under the same conditions.

After the incubation period, the whole stillage was transferred to a filter tube equipped with a 100 uM filter (Millipore) and subjected to centrifugation at 3000 rpm for 5 min. The wet grain or wet cake collected on top of the filter tube was transferred to aluminum pan and dry in moisture balance (Mettler Toledo). The moisture balance will record the sample weight changes in moisture loss at every 30 second interval time. Recording of weight will stop automatically once the machine senses no further change in weight.

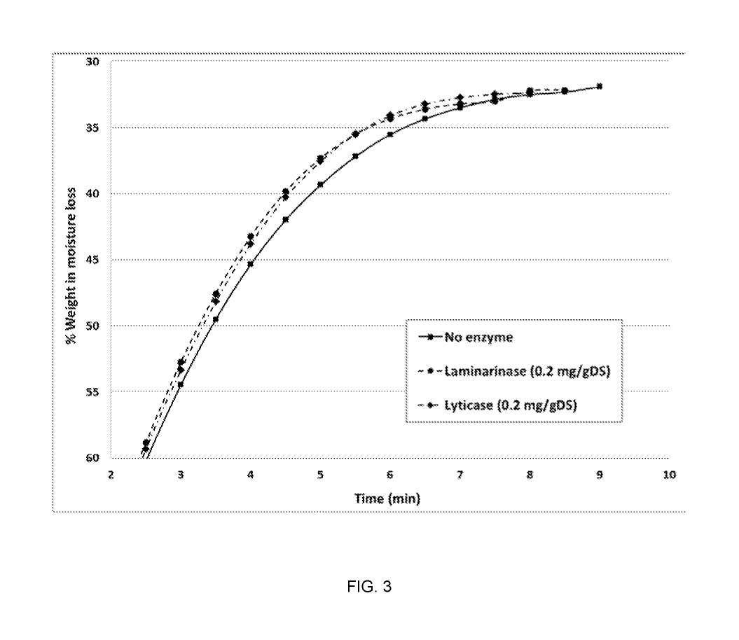

Laminarinase or lyticase hydrolyzes β-glucan components of yeast that are present in whole stillage. Disruption of β-glucan bonds in yeast cells wall will reduce the water retention capability hence facilitate faster drying rate and shorter drying time of wet cake (FIG. 3).

### Example 4

### Effect of Laminarinase or Lyticase (Zymolase) Treatment of Yeast Suspension and the Drying Rate of the Yeast Cells Cake

Laminarinase from Trichoderma sp. and lyticase (zymolase) from Arthrobacter luteus were commercially available from Sigma-Aldrich. Approximately 20 g of yeast was rehydrated in 150 ml of buffer. 15 g of rehydrated yeast suspension was added to a 50 mL incubation tube (Nalgene). Appropriate amount of laminarinase or lyticase was added to yeast suspension and incubated at 65° C. for 2 hours. Control without enzyme addition was prepared and incubated under the same conditions. After the incubation period, the yeast slurry was subjected to centrifugation at 3000 rpm for 5 min and the supernatant was immediately decanted. Yeast pellet or yeast cells cake was then transferred to aluminum pan and dry in moisture balance (Mettler Toledo). The moisture balance will record the sample weight changes in moisture loss at every 30 second interval time. Recording of weight will stop automatically once the machine sense no further change in weight.

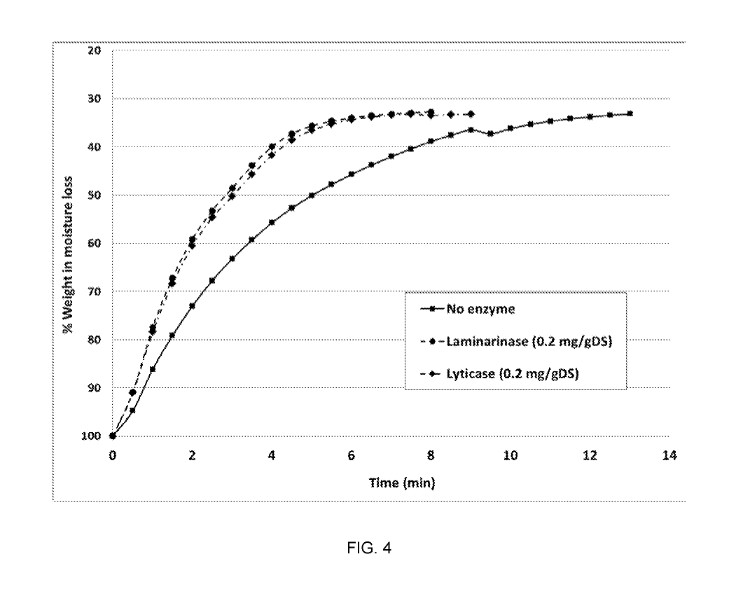

As shown in FIG. 4, hydrolysis of yeast by laminarinase or lyticase increase the drying rate and shorten drying time compared to no enzyme control. Enzymatic lysis of yeast will decrease the cells water retention and consequently dry faster.

1. A method of dewatering whole stillage comprising the steps of
(i) subjecting whole stillage to one or more enzymes capable of degrading yeast cell wall components,
(ii) separating the material into a solid fraction and a liquid fraction.

2. The method of claim 1, wherein the enzyme capable of degrading yeast wall components is selected from the group of laminarinase, lyticase and zymolase.

3. The method of claim 1, wherein the whole stillage is derived from a process of producing a fermentation product, preferably a liquid fermentation product.

4. The method of claim 1, wherein the whole stillage is derived from a process of producing a fermentation product utilizing starch-containing material as a feedstock.

5. The method according to claim 4, wherein the feedstock is selected from the group consisting of corn, wheat, barley, cassava, sorghum, rice, tapioca, rye, potato, sweet potato or any combination thereof.

6. The method of claim 3, wherein the fermentation product is an alcohol.

7. The method of claim 1, wherein the enzyme is added to the whole stillage after the distillation process.

8. The method of claim 1, wherein the enzyme is added to the whole storage during the fermentation process.

9. The method of claim 1 wherein the enzyme is added to the beerwell before the distillation process.

10. The method of claim 1 further comprising a step (iii) of drying the solid fraction.

11. The method of claim 1 wherein the separation in step (ii) is carried out by centrifugation.

12. The method of claim 1, wherein the separation in step (ii) is carried out by filtration.

13. The method of claim 1, wherein step one is carried out at a temperature up to 65° C.

14. The method of claim 1, wherein the step (i) is carried out at a pH range of from 4 to 5.

15. The method of claim 3, wherein the whole stillage is derived from a process of producing a liquid fermentation product.

16. The method of claim 6, wherein the fermentation product is ethanol.

17. The method of claim 11, wherein the separation in step (ii) is carried out by a decanter centrifuge.

18. The method of claim 12, wherein the separation step (ii) is carried out by filtration using a filter press, a screw press, a plate and frame press, a gravity thickener or decker.

19. The method of claim 13, wherein step one is carried out at a temperature of from 20 to 65° C.

20. The method of claim 14, wherein step (i) is carried out at a pH of 4.5.
